(19) United States
(12) Patent Application Publication
(10) Pub. No.: US 2026/0084607 A1
(43) Pub. Date: Mar. 26, 2026

(54) CONTROLLED SYSTEMS FOR MOVING ITEMS IN STORAGE VOLUME OF A VEHICLE

(71) Applicant: REE AUTOMOTIVE LTD

(72) Inventors: Daniel BAREL, Herzliya (IL); Zohar GOLDENSTEIN, Nes-Tziyona (IL); Amnon SHKEDY, Tel-Aviv (IL); Ido GURY, Tel-Aviv Jaffa (IL)

(73) Assignee: REE AUTOMOTIVE LTD, (omitted)

(21) Appl. No.: 19/105,854

(22) PCT Filed: Aug. 14, 2023
(86) PCT No.: PCT/IL2023/050854

§ 371 Date: Feb. 24, 2025

Related U.S. Application Data
(60) Provisional application No. 63/400,859, filed on Aug. 25, 2022.

(51) Int. Cl. B60P 3/00; B60P 1/44

(52) U.S. Cl. CPC B60P 3/007; B60P 1/4471

(57) ABSTRACT

A system for moving items in a storage volume of a van, which may include one or more automatically controlled mechanical devices comprising one or more structures engageable with items within the storage volume, and a controller to control the one or more automatically controlled mechanical devices to engage with the items and to move the items within the storage volume.

### FIELD OF THE INVENTION

The present invention relates to the field of systems for moving items, and more particularly, to automatically controlled systems and devices for moving items in a storage volume of a vehicle.

### BACKGROUND OF THE INVENTION

Typically, loading and unloading of packages into a storage volume of a vehicle is performed by a driver or a loader. Loading and unloading of packages by the driver or the loader may be time consuming and not cost effective. There is a need for automatically controlled systems and devices for loading, unloading and/or moving items in the storage volume of the vehicle.

### SUMMARY OF THE INVENTION

Embodiment of the present invention may provide a system for moving items in a storage volume of a vehicle, which may include: one or more automatically controlled mechanical devices which may include one or more structures engageable with items within the storage volume; and a controller to control the one or more automatically controlled mechanical devices to engage with the items and to move the items within the storage volume.

In some embodiments, the one or more automatically controlled mechanical devices includes: a rail couplable to one of a ceiling or a floor of the storage volume of the vehicle and extending in a longitudinal direction of the storage volume; a sliding member coupled to the rail and movable on the rail in the longitudinal direction; a tray to receive the items, the tray being coupled to the sliding member using a linkage that is extendable and retractable in a vertical direction with respect to the sliding member; and an item holder coupled to the tray, the item holder is to engage with the items and to place the items on the tray.

In some embodiments, at least a part of the tray is rotatable about at axis that is substantially perpendicular to the tray.

In some embodiments, the item holder is movable with respect to the tray in a direction that is transverse to the rail.

In some embodiments, the item holder is movable with respect to the tray in a first direction and in a second direction that is opposite to the first direction, the first direction and the second direction being transverse to the rail.

In some embodiments, the tray includes: a bar coupled to the tray and being transverse to the rail; and a slider movable on the bar in directions that are transverse to the rail; wherein the item holder is coupled to the slider.

In some embodiments, the one or more automatically controlled mechanical devices includes a linkage that couples the item holder to the tray, the linkage being extendable and retractable in directions that are transverse to the rail to move the item holder in said directions.

In some embodiments, the linkage is extendable so as to move the item holder beyond outer edges of the tray.

In some embodiments, the linkage is extendable so as to move the item holder along a substantially straight line.

In some embodiments, the linkage is extendable so as to move the item holder at substantially the same height with respect to the tray.

In some embodiments, the linkage is coupled to the slider of the tray.

In some embodiments, the linkage includes: a first arm coupled to the slider and rotatable with respect to the slider about a first arm rotation axis that is substantially perpendicular to the bar; and a second arm coupled to the first arm and rotatable with respect to the first arm about a second arm rotation axis that is substantially parallel to the first arm rotation axis, the second arm being rotatably coupled to the item holder.

In some embodiments, the one or more automatically controlled mechanical devices includes a linkage actuating mechanism to extend and retract the linkage.

In some embodiments, the linkage actuating mechanism includes: a motor, the motor is to cause the first arm and the second arm of the linkage to rotate about the first arm rotation axis and the second arm rotation axis, respectively, to move the item holder.

In some embodiments, the linkage actuating mechanism includes: a first pulley rotatably coupled to the slider, the first pulley is coupled to the motor and is rotatable by the motor; and a belt interconnecting the first pulley and the second arm of the linkage.

In some embodiments, the linkage actuating mechanism includes: a second pulley rigidly and nonrotatably coupled to the second arm, the second pulley is movable with the second arm as a single body; and wherein the belt interconnects the first pulley and the second pulley.

In some embodiments, the tray includes: a telescopic bar being transverse to the rail, the telescopic bar includes: a first telescopic bar member coupled to the tray; and a second telescopic bar member extendable and retractable with respect to the first telescopic bar member in directions that are transverse to the rail; a slider movable on the second telescopic bar member; wherein the item holder is coupled to the slider.

In some embodiments, the second telescopic bar member is extendable beyond outer edges of the tray to move the item holder beyond the outer edges of the tray.

In some embodiments, the one or more automatically controlled mechanical devices includes: a rail couplable to one of a ceiling or a floor of the storage volume of the vehicle and extending in a longitudinal direction of the storage volume; a sliding member coupled to the rail and movable on the rail in the longitudinal direction; a tray to receive the items, the tray includes a surface extendable and retractable with respect to the tray in directions that are transverse to the rail to engage with the items and to place the items on the tray; and a linkage that couples the tray to the sliding member, the linkage being extendable and retractable in a vertical direction with respect to the sliding member.

In some embodiments, the one or more automatically controlled mechanical devices includes: a rail couplable to one of a ceiling or a floor of the storage volume of the vehicle and extending in a longitudinal direction of the storage volume; a sliding member coupled to the rail and movable on the rail in the longitudinal direction; a tray to receive the items, the tray includes a surface extendable and retractable with respect to the tray in directions that are transverse to the rail to engage with the items and to place the items on the tray; and one or more telescopic bars coupled to the tray, each of the one or more telescopic bars being extendable and retractable with respect to the tray in directions that are transverse to the rail to engage with the items and to place the items on the tray.

In some embodiments, the system includes a plurality of supports assemblable to at least one of shelves, side walls and a floor of the vehicle storage volume, the supports being configured to support the items and being distanced with respect to each other such that hollow spaces are formed between the supports.

In some embodiments, when the extended, each of the one or more telescopic bars is inserted into the hollow space between the respective supports.

In some embodiments, each of the supports includes an increased friction surface to contact the items.

In some embodiments, each of the telescopic bars includes an increased friction surface to contact the items.

In some embodiments, the one or more automatically controlled mechanical devices includes: a rail couplable to one of a ceiling or a floor of the storage volume of the vehicle and extending in a longitudinal direction of the storage volume; a sliding member coupled to the rail and movable on the rail in the longitudinal direction; a tray to receive the items; a linkage that couples the tray to the sliding member, the linkage being extendable and retractable in a vertical direction with respect to the sliding member; and a plurality of structures engageable with the items to place the items on the tray.

In some embodiments, at least a part of the structures is coupled to shelves of the storage volume of the vehicle.

In some embodiments, at least a part of the structures is coupled to a floor of the storage volume of the vehicle.

In some embodiments, at least a part of the structures is coupled to side walls of the storage volume of the vehicle.

In some embodiments, at least a part of the structures includes omni wheels to move the items in directions that are transverse to the rail.

In some embodiments, at least a part of the structures includes conveyors to move the items in directions that are transverse to the rail to place the items on the tray.

In some embodiments, at least a part of the structures includes extendable and retractable surfaces to move the items in directions that are transverse to the rail to place the items on the tray.

In some embodiments, at least a part of the structures includes push and pull actuators to move the items in directions that are transverse to the rail to place the items on the tray.

In some embodiments, the one or more automatically controlled mechanical devices includes: a rail couplable to one of a ceiling or a floor of the storage volume of the vehicle and extending in a longitudinal direction of the storage volume; a sliding member coupled to the rail and movable on the rail in the longitudinal direction; an item holder to engage with the items; a linkage that couples the item holder to the sliding member, the linkage being extendable and retractable in a vertical direction with respect to the sliding member; and a plurality of extendable and retractable surfaces coupled to at least one of shelves and a floor of the storage volume, the extendable surfaces are extendable in directions that are transverse to the rail to move the items in a region below the rail.

In some embodiments, the controller is to control the automatically controlled mechanical device to move the items from a loading location within the storage volume to selected locations within the storage volume.

In some embodiments, the controller is to control the automatically controlled mechanical device to move items from their respective locations within the storage volume to an unloading location within the storage volume.

In some embodiments, the controller is to control the automatically controlled mechanical device to move items from their respective locations within the storage volume to other locations within the storage volume.

In some embodiments, the controller is to control the automatically controlled mechanical device to move items from their respective locations within the storage volume to other locations within the storage volume to balance a center of gravity of the vehicle.

In some embodiments, the controller is to select the items based on at least one of a delivery plan, vehicle geolocation data, items identification data and items storage location data.

In some embodiments, the controller is to identify the items based on signals from sensors disposed on at least one of: one or more components of the automatically controlled mechanical device and walls of the storage volume.

In some embodiments, the controller is disposed within a chassis of the vehicle between an upper surface and a bottom surface of the chassis.

In some embodiments, the system includes a battery to provide power to the automatically controlled mechanical device and the controller.

In some embodiments, the battery is disposed within a chassis of the vehicle between an upper surface and a bottom surface of the chassis.

Embodiments of the present invention provide a vehicle which may include: the system for moving items as described herein; and the storge volume in which the system is assembled.

In some embodiments, the storage volume is removably mountable on a chassis of the vehicle.

In some embodiments, the storage volume is trailable by the vehicle.

In some embodiments, the storage volume includes a plurality of shelves disposed on side walls of the storage volume.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIGS. 1A and 1B are schematic illustrations of a vehicle having a storage volume, and of a system for moving items assembled within vehicle storage volume, according to some embodiments of the invention;

FIG. 2A is a 3D diagram of the vehicle and of a system for moving items, assembled within the vehicle storage volume, according to some embodiments of the invention;

FIGS. 2B and 2C are 3D diagrams of the system of FIG. 2A, according to some embodiments of the invention;

FIG. 2D is a 3D diagram of an enlarged region A of FIG. 2C, according to some embodiments of the invention;

FIGS. 2E and 2F are 2D diagrams of the system of FIGS. 2A-2D in operation, according to some embodiments of the invention;

FIG. 2G shows 2D diagrams of the system of FIGS. 2A-2D in operation within the vehicle storage volume, according to some embodiments of the invention;

FIGS. 3A and 3B are schematic illustrations of a system for moving items and including a tray having a telescopic transverse bar and an item holder coupled to the telescopic transverse bar, according to some embodiments of the invention;

FIGS. 4A and 4B are schematic illustrations of a system for moving items and including a tray having an extendable surface engageable with items, according to some embodiments of the invention;

FIGS. 5A and 5B are 2D diagrams of a system for moving items operating in the vehicle storage volume and including a tray and a plurality of wheels engageable with items, according to some embodiments of the invention;

FIGS. 6A and 6B are 2D diagrams of a system for moving items operating in the vehicle storage volume and including a tray and a plurality of conveyors engageable with items, according to some embodiments of the invention;

FIGS. 7A and 7B are 2D diagrams of a system for moving items operating in the vehicle storage volume and including a tray and a plurality of extendable surfaces engageable with items, according to some embodiments of the invention;

FIGS. 8A and 8B are 2D diagrams of a system for moving items operating in the vehicle storage volume and including a tray and a plurality of actuators engageable with items, according to some embodiments of the invention;

FIG. 9 is a 2D diagram of a system for moving items operating in the vehicle storage volume and including an item holder movable on a rail and a plurality of extendable surfaces engageable with items, according to some embodiments of the invention;

FIG. 10A is a 3D diagram of the vehicle and of a system for moving items and including item supports and a tray with telescopic bars, assembled within the vehicle storage volume, according to some embodiments of the invention.

FIG. 10B is a 3D diagram of shelves of the vehicle storage volume and of the system of FIG. 2A, according to some embodiments of the invention.

FIG. 10C is a 3D diagram of an enlarged region C of FIG. 10B, according to some embodiment of the invention; and

FIGS. 10D and 10E are 3D diagrams of a rail, slider, linkage, tray and telescopic bars of the system of FIGS. 10A-10C, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

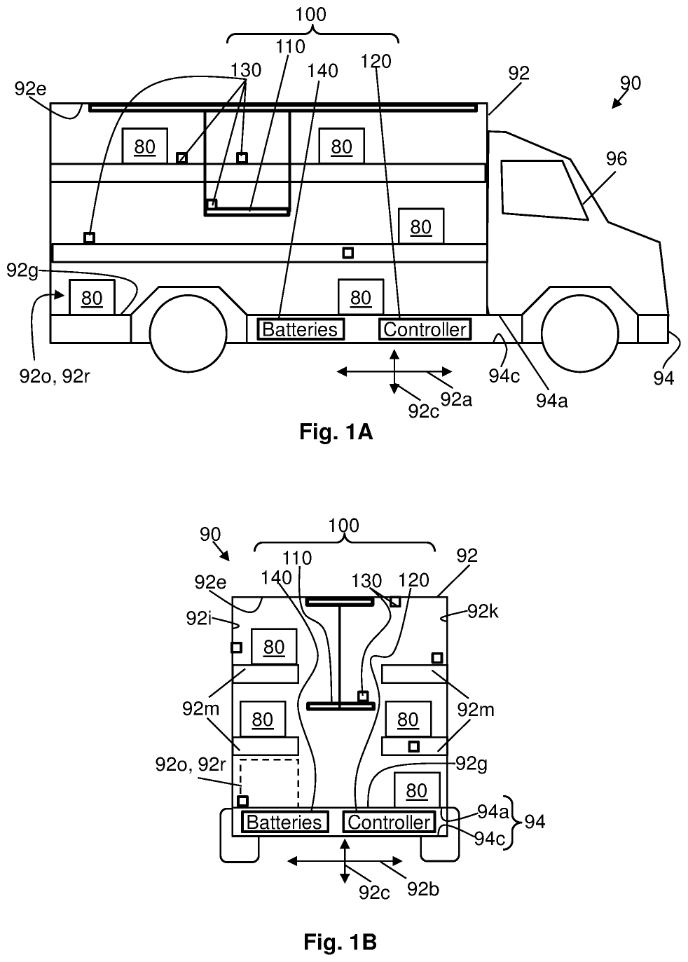

Reference is made to FIGS. 1A and 1B, which are schematic illustrations of a vehicle 90 having a storage volume 92, and of a system 100 (e.g. displacement system) for moving items 80 assembled within vehicle storage volume 92, according to some embodiments of the invention. FIG. 1A shows a schematic side view and FIG. 1B shows a schematic rear view of vehicle 90 and system 100.

Vehicle 90 may have a storage volume 92. Vehicle storage volume 92 may have a longitudinal direction 92a, a transverse direction 92b and a vertical direction 92c. Vehicle storage volume 92 may have walls, e.g. ceiling 92e, floor 92g, first side wall 92i and second side wall 92k. Vehicle storage volume 92 may have shelves 92m. Shelves 92m may be disposed on the walls, for example, side walls 92i, 92k. Storage volume 92 may store items 80. Items 80 may be stored on or within, for example, shelves 92m, floor 92g or any suitable location within vehicle storage volume 92. Items 80 may include packages, boxes, envelopes, unboxed goods, containers for accommodating goods or any other suitable items.

Vehicle 90 may be a van. Vehicle 90 may be a delivery van. Vehicle 90 may be a truck. Vehicle 90 may be a van that a person or a robotic system can walk-in (e.g. a walk-in van). Vehicle storage volume 92 may be mounted (e.g. removably mounted) on a chassis 94 of vehicle 90. Vehicle storage volume 92 may be trailed by vehicle 90. While vehicle 90 is described herein as a wheeled vehicle, vehicle 90 may be any land vehicle, airborne vehicle or naval vehicle having storage volume 92.

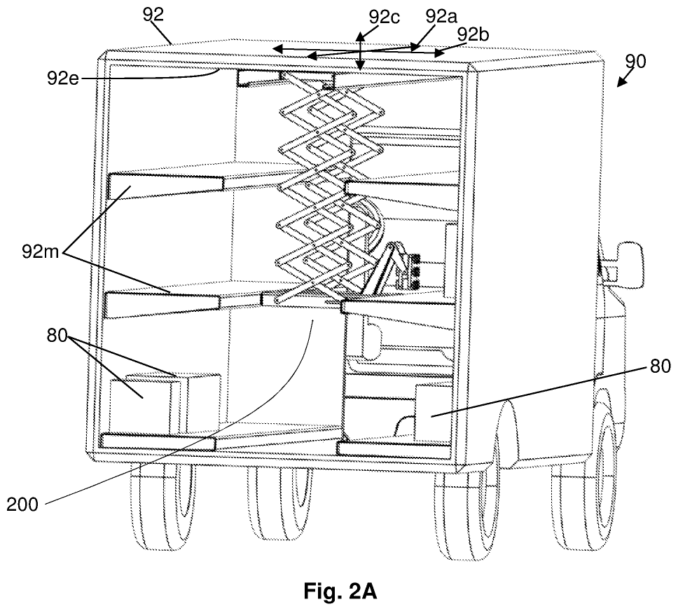

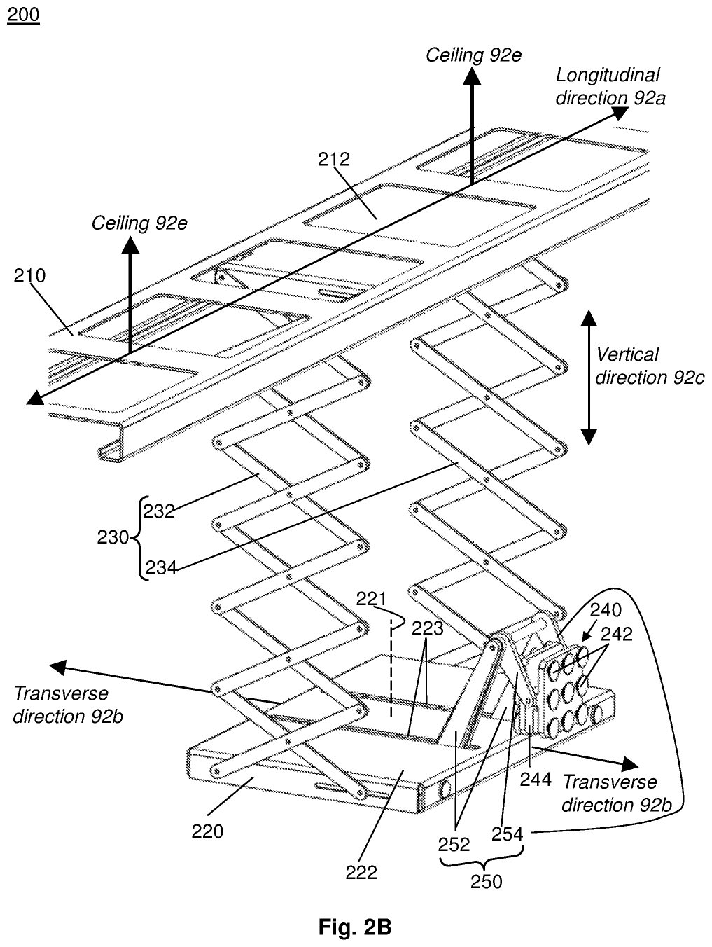

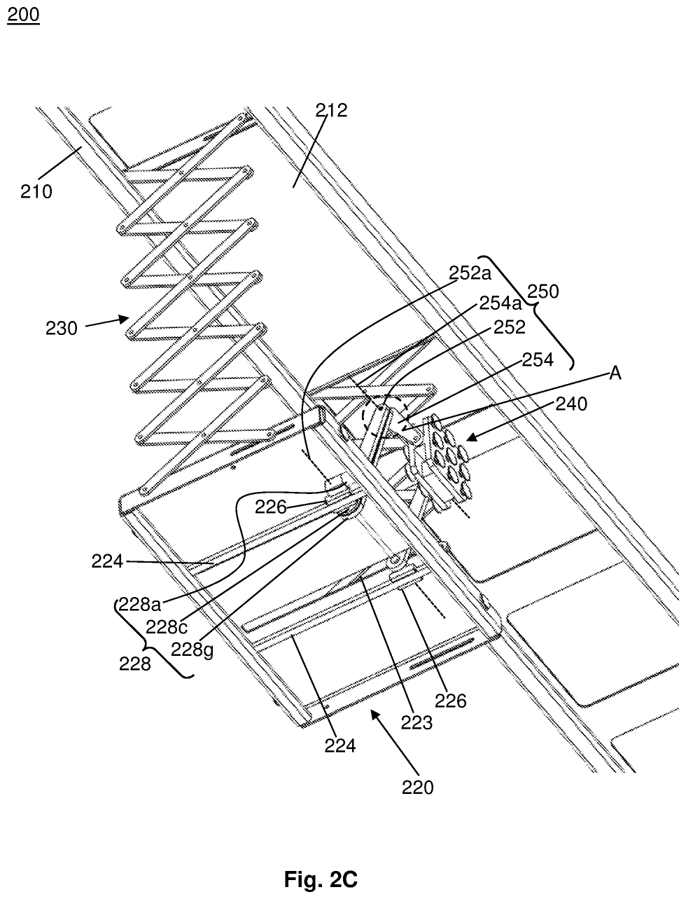

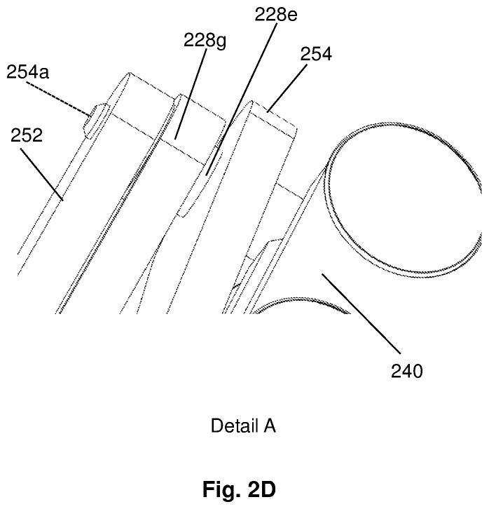

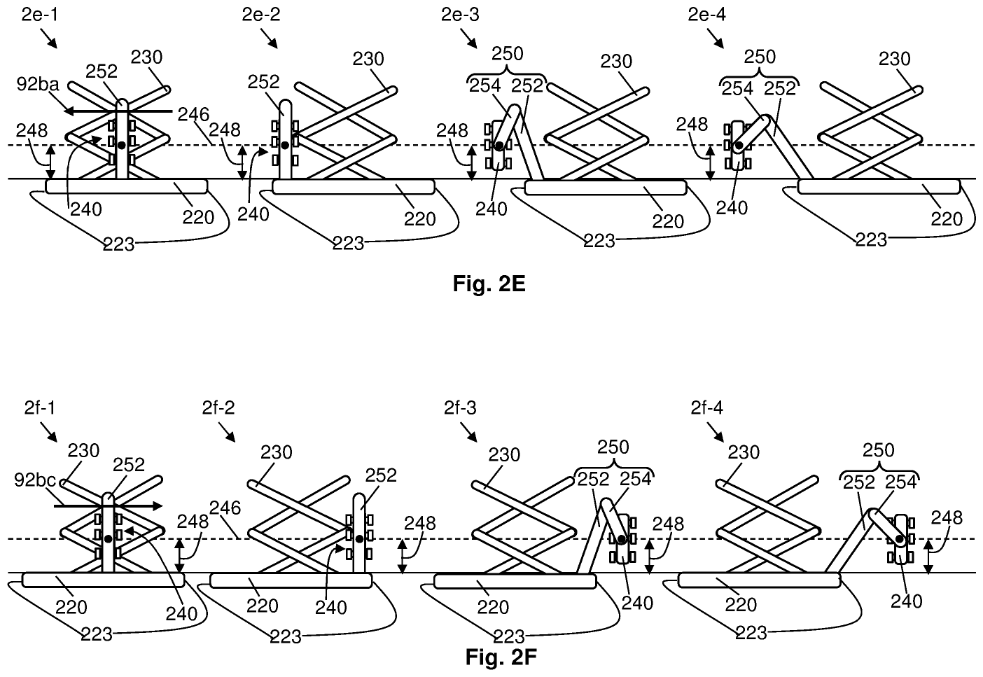

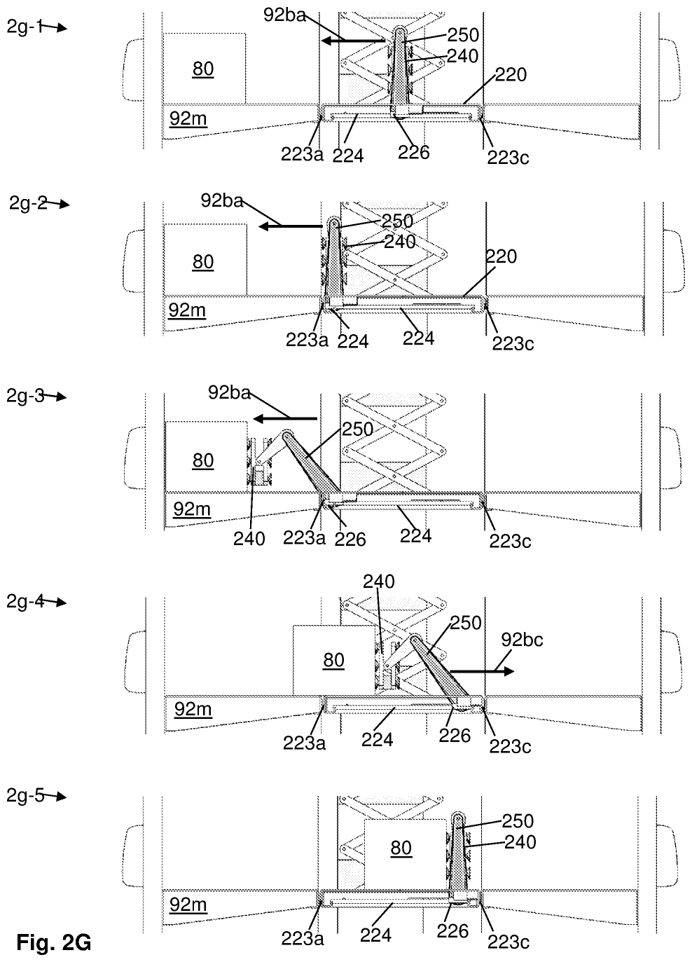

System 100 may include one or more automatically controlled mechanical devices 110 (e.g. one or more items manipulators 110) having one or more structures that may engage with items 80. The system may include a controller 120 to control one or more mechanical devices 110, e.g. to load items 80 to selected locations in storage volume 92, unload items 80 from their respective locations within storage volume 92 and/or move items 80 from their respective locations within storage volume 92 to other locations within vehicle storage volume 92. Various embodiments of systems for moving items are described hereinbelow with respect to FIGS. 2A-2G, 3A-3B, 4A-4B, 5A-5B, 6A-6B, 7A-7B, 8A-8B, 9 and 10A-10E.

During loading of items 80 into vehicle storage volume 92, controller 120 may control one or more mechanical devices 110 to pick up items 80 from a loading location 920 within vehicle storage volume 92 (e.g. near a door of vehicle storage volume 92 or a dedicated loading port of vehicle storage volume 92) or external to vehicle storage volume 92 and move items 80 to selected locations within storage volume 92. Controller 120 may select locations of each of items 80 being loaded into vehicle storage volume 92 based on, for example, weights of the respective items, for example to balance the center of gravity of vehicle 90. Controller 120 may be, for example, disposed within chassis 94 of vehicle 90, e.g. between an upper surface 94a and a bottom surface 94c of chassis 94. Controller 120 may be disposed at various locations within vehicle 90, e.g. within storage volume 92, a driver cabin 96 on one or more components of mechanical device 110 or at any other suitable location.

During delivery, controller 120 may control one or more mechanical devices 110 to pick up selected items 80 from their respective locations within storage volume 92 and to move selected items 80 to an unloading location 92r within storage volume 92 (e.g. near the door of vehicle storage volume 92 or a dedicated unloading port of vehicle storage volume 92) or external to vehicle storage volume 92. Unloading location 92r may be, for example, the same as loading location 920. The selection of items for unloading may be based on, for example, a delivery plan, van geolocation data, items identification data, items storage location data and/or any other suitable data. For example, based on the van geolocation data and the delivery plan, controller 120 may select the items that need to be unloaded from vehicle 90 at the next target delivery location. Based on the items storage location data and/or the items identification data, controller 120 may control one or more mechanical devices 110 to pick up selected items 80 from their respective locations within storage volume 92 and move selected items 80 to unloading location 92r within vehicle storage volume 92. Controller 120 may control one or more mechanical devices 110 to move selected items 80 from their respective locations within storage volume 92 to other locations within storage volume 92 to, for example, balance the center of gravity of vehicle 90. Moving selected items 80 to unloading location 92r may be performed by one or more mechanical devices 110 automatically while vehicle 90 is travelling to the next target delivery location such that when vehicle 90 arrives at the next target delivery location selected items 80 will be ready for unloading from unloading location 92r. Selection of items for unloading and movement of selected items 80 to unloading location 92r may be also intimated by an operator (e.g. the driver or the loader). Accordingly, the operator does not need to walk into vehicle storage volume 92 and look for the items that need to be unloaded thus saving time and costs.

System 100 may include a plurality of sensors 130. Based on signals from sensors 130, controller 120 may identify items 80. Sensors 130 may be disposed on one or more components of one or more mechanical devices 110, items 80 and/or within vehicle storage volume 92 (e.g. on floor 92g, side walls 92i, 92k, shelves 92m or any other suitable location within vehicle storage volume 92). For example, sensors 130 may include radiofrequency transmitters that may read data from radiofrequency identification (RFID) tags; laser readers that may read laser marks; cameras that may read QR codes; or any other suitable sensors that may read identification data. The tags and/or markings may be made on items 80 and/or on floor 92g, side walls 92i, 92k and/or shelves 92m of vehicle storage volume 92. Based on signals from sensors 130, controller 120 may identify selected items 80, identify selected locations with vehicle storage volume 92, identify selected locations on shelves 92 (e.g. empty or occupied locations or spaces) or perform any other suitable action.

System 100 may include one or more batteries 140. One or more batteries 140 may provide power to components of system 100 (e.g. to one or more components of one or more mechanical devices 110, controller 120, sensors 130 or any other suitable components of system 100). One or more batteries 140 may be, for example, disposed within chassis 94 of vehicle 90, e.g. between upper surface 94a and bottom surface 94c of chassis 94. Having one or more batteries 140 disposed withing chassis 94 may, for example, hollow space within storage volume 92 or cabin 96. One or more batteries 140 may be disposed at various locations within vehicle 90, e.g. within storage volume 92, driver cabin 96, one or more components of one or more components of mechanical device 110 or at any other suitable location. System 100 may include one or more cable guides (not explicitly shown), e.g. to supply power to components of system 100.

The following illustrations/description depict embodiments of systems for moving items 80. Each of the embodiments may include features from other embodiments presented, and embodiments not specifically described may include various features described herein.

Reference is made to FIG. 2A, which is a 3D diagram of vehicle 90 and of a system 200 for moving items 80, assembled within vehicle storage volume 92, according to some embodiments of the invention.

Reference is also made to FIGS. 2B and 2C, which are 3D diagrams of system 200 of FIG. 2A, according to some embodiments of the invention. FIGS. 2B and 2C show different perspective views of system 200. FIGS. 2B and 2C show different perspective views of system 200.

Reference is also made to FIG. 2D, which is a 3D diagram of an enlarged region A of FIG. 2C, according to some embodiments of the invention.

System 200 may operate as system 100 moving items 80 within vehicle storage volume 92 (e.g. as described above with respect to FIGS. 1A and 1B).

System 200 may include a rail 210. Rail 210 may be coupled to ceiling 92e or floor 92g of vehicle storage volume 92. Rail 210 may extend in longitudinal direction 92a of storage volume 92. In the example of FIGS. 2A-2C, rail 210 is coupled to ceiling 92e and extending in a region between shelves 92m of storage volume 92 (e.g. as shown in FIG. 2A). Rail 210 may be coupled in regions other than between shelves 92m.

System 200 may include a sliding member 212. Sliding member 212 may be coupled to rail 210. Sliding member 212 may move on rail 210 in longitudinal direction 92a.

System 200 may include a tray 220. Tray 220 may receive items 80. Tray 220 may temporarily accommodate items 80. Tray 220 may include a surface 222 to receive and accommodate items 80 thereon.

System 200 may include a linkage 230. Linkage 230 may couple tray 220 to sliding member 212. Linkage 230 may be extendable and retractable with respect to sliding member 212 in vertical direction 92c of storage volume 92. Linkage 230 may elevate and lower tray 220 with respect to sliding member 212. In the example of FIGS. 2A-2C, linkage 230 includes two scissor linkages 232, 234 coupled to tray 220 at opposing longitudinal ends of tray 220. Linkage 230 may include a single scissor linkages (e.g. one of single scissor linkages 232, 234) coupled to one side of tray 220 (e.g. to which may provide more open tray 220). Linkages other than scissor linkages 232, 234 may be used to couple tray 220 to sliding member 212 and to elevate and lower tray 220 with respect to sliding member 212. For example, linkage 230 may include one or more telescopic arms that may couple tray 220 to sliding member 212 or any other suitable linkage.

At least part of tray 220 may be rotatable about an axis 221 that is perpendicular (or substantially perpendicular) to tray 220 (e.g. axis 221 as shown in FIG. 2B). For example, tray 220 may be rotatable with respect to sliding member 212 about axis 221. In another example, surface 222 of tray 222 may be rotatable with respect to tray 220 about axis 221.

System 200 may include an item holder 240. Item holder 240 may be coupled to tray 220. Item holder 240 may engage with items 80. Item holder 240 may hold items 80. In the example of FIGS. 2A-2C, item holder 240 includes suction cups 242. Item holder 240 may include devices other than suction cups 242 to engage and/or hold items 80. For example, item holder 240 may include gripping arms, anchors, hook and loop components, or any other suitable devices.

Item holder 240 may move on tray 220. Item holder 240 may move on tray 220 in directions that are transverse (or substantially transverse) to rail 210. Item holder 240 may move on tray 220 in direction that is parallel (or substantially parallel) to transverse direction 92b of storage volume 92 (e.g. as described below with respect to FIGS. 2E, 2F and 2G). For example, tray 220 may include a bar 224 coupled to (e.g. coupled within) tray 220 and being transverse to rail 210, and a slider 226 that may move on bar 224. Item holder 240 may be coupled to slider 226.

System 200 may include a linkage 250 that may couple item holder 240 to tray 220. For example, linkage 250 may couple item holder 240 to slider 226 of tray 220. Linkage 250 may be extendable and retractable in directions that are transverse to rail 212 (e.g. in directions that are parallel (or substantially parallel) to transverse direction 92b of vehicle storage volume 92) to move item holder 240 in said directions.

Linkage 250 may include a first arm 252. First arm 252 may be coupled to slider 226 (e.g. as shown in FIGS. 2B and 2C). First arm 252 may rotate with respect to slider 226 about a first arm axis 252a that is perpendicular (or substantially perpendicular) to bar 224 (e.g. as shown in FIG. 2C). Second arm 254 may rotate with respect to first arm 252 about a second arm rotation axis 254a that is parallel (or substantially parallel) to first arm rotation axis 252a (e.g. as shown in FIG. 2C). Second arm 254 may be coupled (e.g. rotatably) to item holder 240 (e.g. as shown in FIGS. 2B and 2C). Item holder 240 may include a weight 244 to maintain a vertical (or substantially vertical) orientation of item holder 240 (e.g. as shown in FIG. 2B).

System 200 may include a linkage actuating mechanism 228. Linkage actuating mechanism 228 may extend and retract linkage 250. Linkage actuating mechanism may rotate first arm 252 and second arm 254 of linkage 250 (e.g. as shown in FIG. 2C). Linkage actuating mechanism 228 may include a transmission to interconnect first arm 252 and second arm 254. Linkage actuating mechanism 228 may include a motor 228a coupled to slider 226. Motor 228a may cause first arm 252 and second arm 254 of linkage 250 to rotate about first arm rotation axis 252a and second arm rotation axis 254a, respectively, to move item holder 240 in directions transverse to rail 212. For example, linkage actuating mechanism 228 may include a first pulley 228c rotatably coupled to slider 226 and configured to be rotated by motor 228a, a second pulley 228e nonrotatably coupled to second arm 254, and a belt 228g interconnecting first pulley 228c and second pulley 228e. In some embodiments, linkage actuating mechanism 228 includes a transmission gear interconnecting first pulley 228c and second pulley 228e. Second pulley 228e may be disposed along second arm rotation axis 254a (e.g. as shown in FIG. 2D). Second pulley 228e may be circular member formed as integral portion of second arm 254 (e.g. as shown in FIG. 2D). Rotation of first pulley 228c by motor 228a may cause second arm 254 to rotate respect to first arm 252 and further cause first arm 252 to rotate with respect to slider 226 to move item holder 240 in directions that are transverse to rail 212.

Tray 220 may include a transverse slot 223 formed through its surface 222 through which first arm 252 may extend. Linkage 250 may include a second arm 254. Second arm 254 may be coupled to first arm 252 (e.g. as shown in FIGS. 2B and 2C). Tray 220 may include a pair of slots 223, a pair of bars 224 and a pair of sliders 226; and linkage 250 may include a pair of first arms 252 and a pair of second arms 254 (e.g. as show in FIGS. 2B and 2C).

Reference is made to FIGS. 2E and 2F, which are 2D diagrams of automatically controlled mechanical system 200 of FIGS. 2A-2D in operation, according to some embodiments of the invention.

Linkage 250 may be extendable and retractable in directions that are transverse to rail 212 (e.g. in directions that are parallel to transverse direction 92b of vehicle storage volume 92) to move item holder 240 in said directions. For example, illustrations 2e-1, 2e-2, 2e-3 and 2e-4 in FIG. 2E show extension of linkage 250 a first transverse direction 92ba (that is parallel (or substantially parallel) to transverse direction 92b of vehicle storage volume 92) to move item holder 240 in said first transverse direction 92ba. In another example, illustrations 2f-1, 2f-2, 2f-3 and 2f-4 in FIG. 2F show extension of linkage 250 in a second transverse direction 92bc that is opposite to first transverse direction 92ba to move item holder 240 in said second transverse direction 92bc. Linkage 250 may be extendable so as to move item holder 240 beyond outer edges 223 of tray 220 in said directions (e.g. as shown in FIGS. 2E and 2F). Linkage 250 may move item holder 240 along a substantially straight line 246 (that is parallel to transverse direction 92b of vehicle storage volume 92; e.g. as shown in FIGS. 2E and 2F). Linkage 250 may move item holder 240 at substantially the same height 248 with respect to tray 220 (e.g. as shown in FIGS. 2E and 2F).

Assembling item holder 240 on slider 226 movable on bar 224 in transverse directions 92ba, 92bc using linkage 250 extendable and retractable in transverse directions 92ba, 92bc may provide an extended movement range for item holder 240 to engage with items 80 disposed on shelves 92m and/or floor 92g of vehicle storage volume 92. Configuring linkage 250 to move item holder 240 along substantially straight line 246 and/or at substantially the same height 248 with respect to tray 220 may provide compact system 200. Such system 200 may be easily retrofitted within vehicle storage volume 92 without making any changes (or any significant changes) to vehicle storage volume 92.

The controller (e.g. such as controller 120 as described above with respect to FIGS. 1A and 1B) may control components of system 200 (e.g. sliding member 212, linkage 230, slider 226 and linkage 250) to move items 80 within vehicle storage volume 92.

Reference is made to FIG. 2G, which shows 2D diagrams of automatically controlled mechanical system 200 of FIGS. 2A-2D in operation within vehicle storage volume 92, according to some embodiments of the invention.

In operation 2g-1, the controller may control system 200 to bring tray 220 in front of selected item 80. Item holder 240 may be disposed in the middle (or substantially in the middle) of tray 220 between a first lateral edge 223a and a second lateral edge 223c of tray 220 (e.g. wherein second lateral edge 223c is opposing to first lateral edge 223a). In operation 2g-2, slider 226 may be moved along bar 224 in first transverse direction 92ba towards first lateral edge 223a of tray 220 to bring item holder 240 adjacent to first lateral edge 223a of tray 220. In operation 2g-3, linkage 250 may be extended in first transverse direction 92ba to engage with item 80 disposed on shelf 92m. In operation 2g-4, slider 226 may be moved on bar 224 in second transverse direction 92bc towards second lateral edge 223c of tray 220 to pull item holder 240 and item 80 engaged therewith towards tray 220. In operation 2g-5, linkage 250 may be retracted in second transverse direction 92bc to bring item holder 220 adjacent to second lateral edge 223c of tray 220 and to position the entire item 80 engaged with item holder 240 on tray 220. Tray 220 with item 80 disposed on tray 220 and being held by item holder 240 may be further moved towards a desired location (e.g. unloading location 92r) and unload item 80 from tray 220 at the desired location. The unloading of item 80 from tray 220 may be performed by initiating operations 2g-1 to 2g-5 in a reverse order to that described with respect to FIG. 2G.

System 200 may include additional components that are not shown in FIGS. 2A-2G for simplicity. For example, system 200 may include a controller (e.g. such as controller 120 described above with respect to FIGS. 1A-1B). The controller may control components of system 200 (e.g. sliding member 212, linkage 230, linkage 250 or any other suitable component) to load items 80 to selected locations in vehicle storage volume 92, unload selected items 80 from their respective locations within vehicle storage volume 92 and/or move selected items 80 from their respective locations within vehicle storage volume 92 to other locations within vehicle storage volume 92 (e.g. as described above with respect to FIGS. 1A and 1B). System 200 may include sensors (e.g. such as sensors 130 described above with respect to FIGS. 1A-1B), one or more batteries (e.g. such as one or more batteries 140 described above with respect to FIGS. 1A-1B) or any other suitable components.

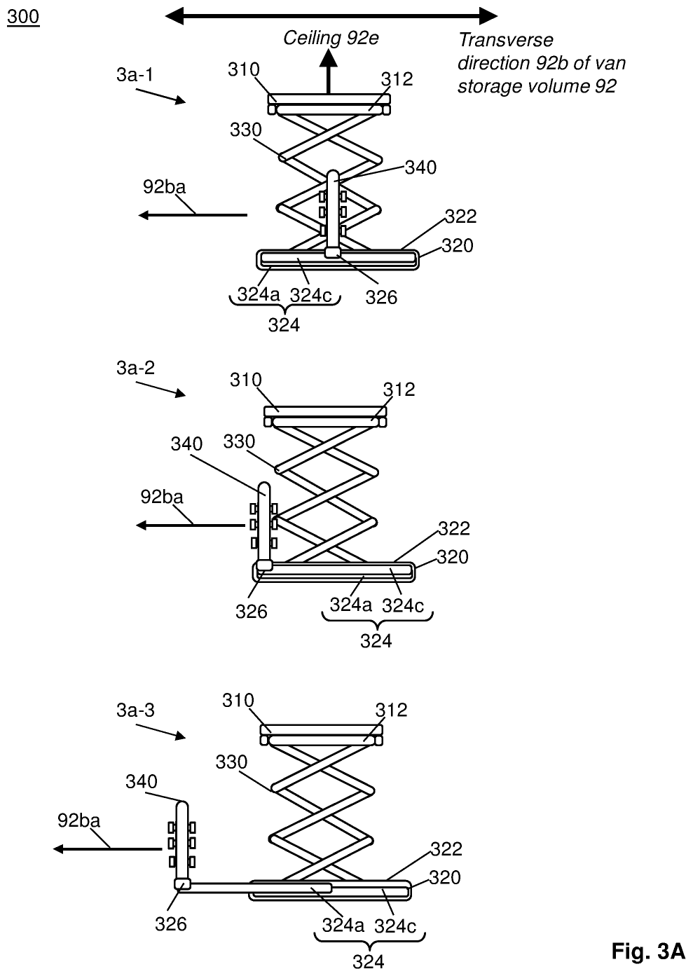

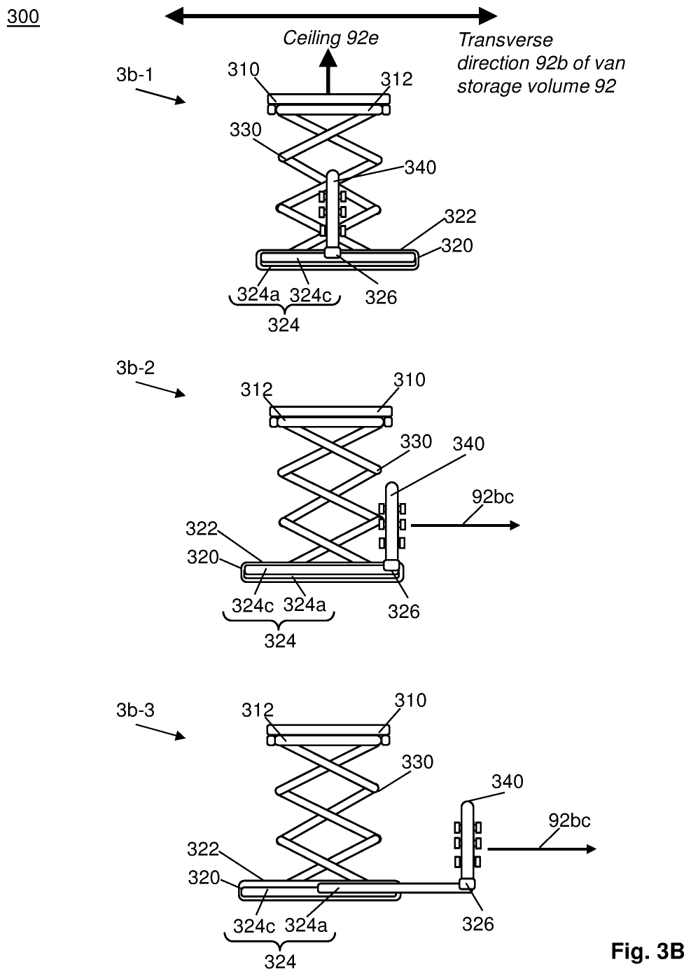

Reference is made to FIGS. 3A and 3B, which are schematic illustrations of system 300 (e.g. displacement system) for moving items 80 and including a tray 320 having a telescopic transverse bar 324 and an item holder 340 coupled to telescopic bar 324, according to some embodiments of the invention. Illustrations 3a-1, 3a-2 and 3a-3 in FIG. 3A and illustrations 3b-1, 3b-2 and 3b-3 in FIG. 3B show item holder 340 at different positions with respect to tray 320.

System 300 may operate as system 100 for moving items 80 within vehicle storage volume 92 (e.g. as described above with respect to FIGS. 1A and 1B).

System 300 may include a rail 310 (e.g. such as rail 210 described hereinabove). Rail 310 may be coupled to ceiling 92e or floor 92g of vehicle storage volume 92 and may extend in longitudinal direction 92a of storage volume 92. System 300 may include a sliding member 312 (e.g. such as sliding member 212 described hereinabove) that may be coupled to rail 310 and may move on rail 310 in longitudinal direction 92a.

System 300 may include a tray 320. Tray 320 may receive items 80. Tray 320 may temporarily accommodate items 80. Tray 320 may include a surface 322 to receive and accommodate items 80 thereon. System 300 may include a linkage 330 (e.g. such as linkage 230 described hereinabove) to elevate and lower tray 320 with respect to sliding member 312. At least part of tray 320 may be rotatable about an axis that is perpendicular (or substantially perpendicular) to tray 320 (e.g. as described above with respect to FIGS. 2A-2D).

System 300 may include an item holder 340 (e.g. such as item holder 240 described hereinabove). Item holder 340 may engage with items 80. Item holder 340 may move with respect to tray 320, e.g. in directions that are transverse (or substantially transverse) to rail 310 and that are parallel (or substantially parallel) to transverse direction 92b of vehicle storage volume 92. Item holder 340 may move with respect to tray 320 in first transverse direction 92ba (e.g. as shown in FIG. 3A). Item holder 340 may move with respect to tray 320 in second transverse direction 92bc opposing to first transverse direction 92ba (e.g. as shown in FIG. 3B).

Tray 320 may include a bar 324 coupled to (e.g. coupled within) tray 320 and being transverse to rail 310, and a slider 326 that may move on bar 324 and to which item holder 340 may be coupled. Bar 324 may be a telescopic bar. Bar 324 may include a first telescopic bar member 324a that may be coupled to or within tray 320 and a second telescopic bar member 324c that may be extendable and retractable with respect first telescopic bar member 324a in directions that are transverse (or substantially transverse) to rail 310 and that are parallel (or substantially parallel) to transverse direction 92b of vehicle storage volume 92. For example, second telescopic bar member 324c may be extendable and retractable with respect first telescopic bar member 324a in first transverse direction 92ba (e.g. as shown in FIG. 3A) and/or second transverse direction 92bc (e.g. as shown in FIG. 3B). Second telescopic bar member 324c may be extendable with respect to first telescopic bar member 324a to move item holder 340 beyond outer edges 323 of tray 320 (e.g. as shown in FIGS. 3A and 3B).

System 300 may be operated similarly to system 200 to pull items 80 from shelves 92m or floor 92g of vehicle storage volume 92 onto tray 320 and to move items 80 to desired locations within vehicle storage volume 92 (e.g. as described above with respect to FIG. 2G).

System 300 may include additional components that are not shown in FIGS. 3A-3B for simplicity. For example, system 300 may include a controller (e.g. such as controller 120 described above with respect to FIGS. 1A-1B), sensors (e.g. such as sensors 130 described above with respect to FIGS. 1A-1B), one or more batteries (e.g. such as one or more batteries 140 described above with respect to FIGS. 1A-1B) or any other suitable components.

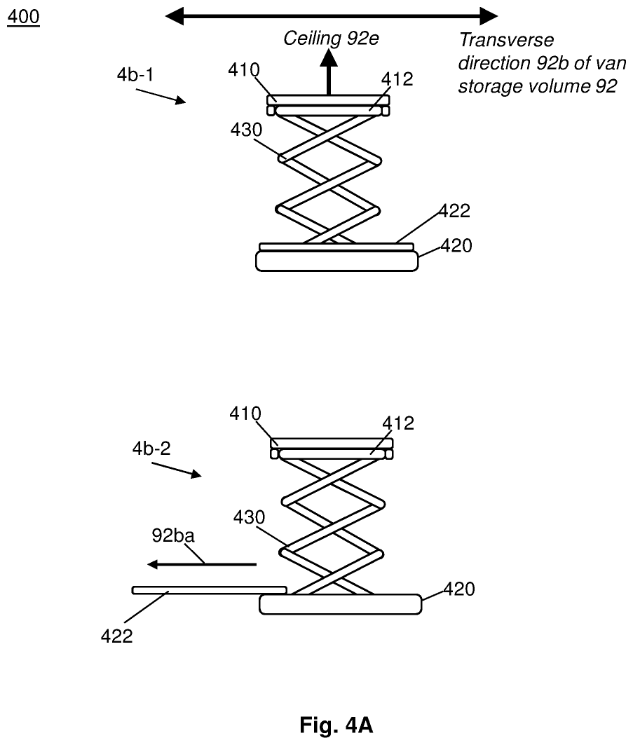

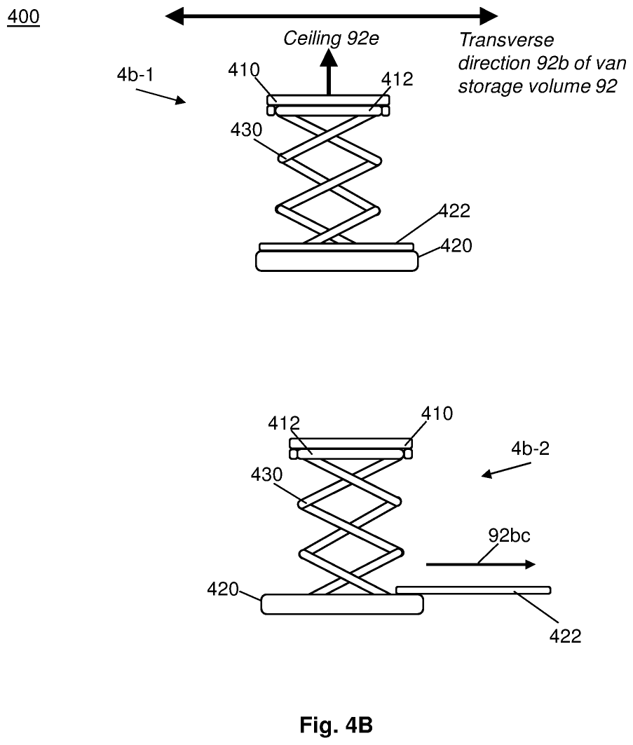

Reference is made to FIGS. 4A and 4B, which are schematic illustrations of a system 400 (e.g. displacement system) for moving items 80 and including a tray 420 having an extendable surface 422 engageable with items 80, according to some embodiments of the invention. Illustrations 4a-1 and 4a-2 in FIG. 4A and illustrations 4b-1 and 4b-2 in FIG. 4B show surface 422 at different positions with respect to tray 420.

System 400 may operate as system 100 for moving items 80 within vehicle storage volume 92 (e.g. as described above with respect to FIGS. 1A and 1B).

System 400 may include a rail 410 (e.g. such as rail 210 described hereinabove). Rail 410 may be coupled to ceiling 92e or floor 92g of vehicle storage volume 92 and may extend in longitudinal direction 92a of storage volume 92. System 400 may include a sliding member 412 (e.g. such as sliding member 212 described hereinabove) that may be coupled to rail 410 and may move on rail 410 in longitudinal direction 92a.

System 400 may include a tray 420. Tray 420 may receive items 80. Tray 420 may temporarily accommodate items 80. System 400 may include a linkage 430 (e.g. such as linkage 230 described hereinabove) to elevate and lower tray 420 with respect to sliding member 412.

Tray 420 may include a surface 422 to receive and accommodate items 80 thereon. Surface 422 may be extendable and retractable with respect to tray 420. Surface 422 may be extendable in directions that are transverse (or substantially transverse) to rail 410 and that are parallel (or substantially parallel) to transverse direction 92b of vehicle storage volume 92. Surface 422 may be extendable in first transverse direction 92ba (e.g. as shown in FIG. 4A). Surface 422 may be extendable in second transverse direction 92bc opposing to first transverse direction 92ba (e.g. as shown in FIG. 4B). At least part of tray 420 may be rotatable about an axis that is perpendicular (or substantially perpendicular) to tray 420 (e.g. as described above with respect to FIGS. 2A-2D).

System 400 may be operated similarly to system 200 to pull items 80 from shelves 92m or floor 92g of vehicle storage volume 92 onto tray 420 and to move items 80 to desired locations within vehicle storage volume 92 (e.g. as described above with respect to FIG. 2G).

System 400 may include additional components that are not shown in FIGS. 4A-4B for simplicity. For example, system 400 may include a controller (e.g. such as controller 120 described above with respect to FIGS. 1A-1B), sensors (e.g. such as sensors 130 described above with respect to FIGS. 1A-1B), one or more batteries (e.g. such as one or more batteries 140 described above with respect to FIGS. 1A-1B) or any other suitable components.

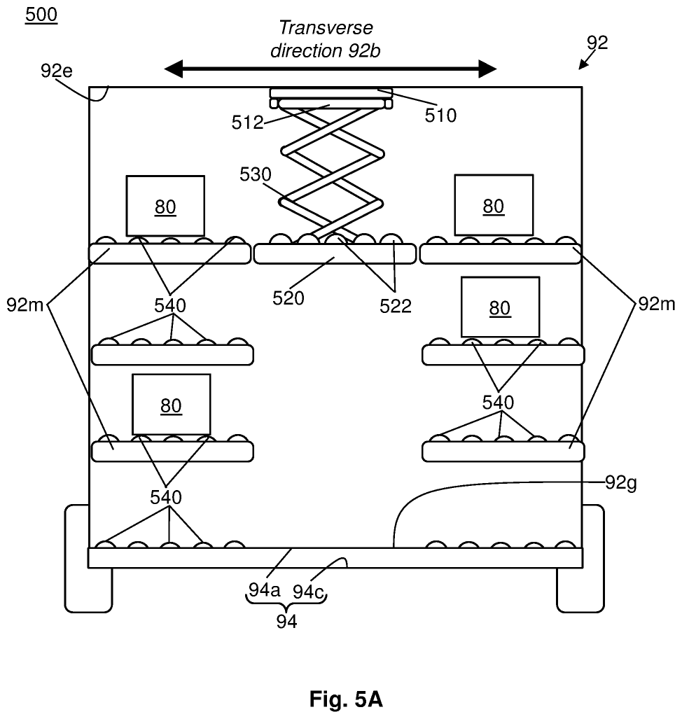

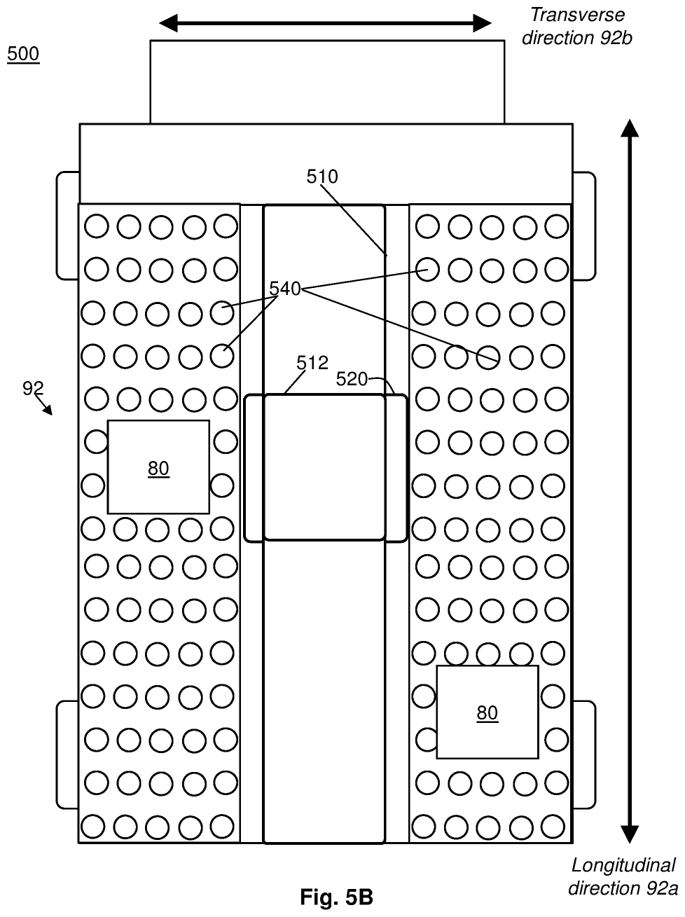

Reference is made to FIGS. 5A and 5B, which are 2D diagrams of a system 500 (e.g. displacement system) for moving items 80 operating in vehicle storage volume 92 and including a tray 520 and a plurality of wheels 540 engageable with items 80, according to some embodiments of the invention. FIGS. 5A and 5B show schematic rear and top views of system 500 and vehicle storage volume 92.

System 500 may operate as system 100 for moving items 80 within vehicle storage volume 92 (e.g. as described above with respect to FIGS. 1A and 1B).

System 500 may include a rail 510 (e.g. such as rail 210 described hereinabove) that may be coupled to ceiling 92e or floor 92g of vehicle storage volume 92 and extending in longitudinal direction 92a of storage volume 92. System 500 may include a sliding member 512 (e.g. such as sliding member 212 described hereinabove) that may be coupled to rail 510 and may move on rail 510 in longitudinal direction 92a.

System 500 may include a tray 520. Tray 520 may receive items 80. Tray 520 may temporarily accommodate items 80. At least part of tray 520 may be rotatable about an axis that is perpendicular (or substantially perpendicular) to tray 520 (e.g. as described above with respect to FIGS. 2A-2D). System 500 may include a linkage 530 (e.g. such as linkage 230 described hereinabove) to elevate and lower tray 520 with respect to sliding member 512.

System 500 may include a plurality of wheels (e.g. omni wheels) 540. Wheels 540 may be coupled to shelves 92m and/or floor 92g of vehicle storage volume 92 (e.g. as shown in FIGS. 5A and 5B). Items 80 may be disposed on wheels 540. Subsets of wheels 540 may be rotated to move items 80 in directions that are perpendicular (or substantially perpendicular) to rail 512 and are parallel (or substantially parallel) to transverse direction 92b of vehicle storage volume 92.

In operation, tray 520 may be moved to position tray 520 in front of selected item 80, while respective subset of wheels 540 may be rotated to move selected item 80 to tray 520. Tray 520 may be then moved to the desired location within storage volume 92 and selected item 80 may be unloaded from tray 520 at the desired location.

In some embodiments, tray 520 includes a structure 522 that may engage with items 80 to facilitate loading of items 80 on tray 520 or unloading of items 80 from tray 520. In the example, of FIGS. 5A and 5B, structure 522 includes wheels (e.g. omni wheels). Structure 522 may include devices other than wheels 522. For example, structure 522 may include a conveyor belt, rollers, or any other suitable device that may engage with items 80.

System 500 may include additional components that are not shown in FIGS. 5A-5B for simplicity. For example, system 500 may include a controller (e.g. such as controller 120 described above with respect to FIGS. 1A-1B), sensors (e.g. such as sensors 130 described above with respect to FIGS. 1A-1B), one or more batteries (e.g. such as one or more batteries 140 described above with respect to FIGS. 1A-1B) or any other suitable components.

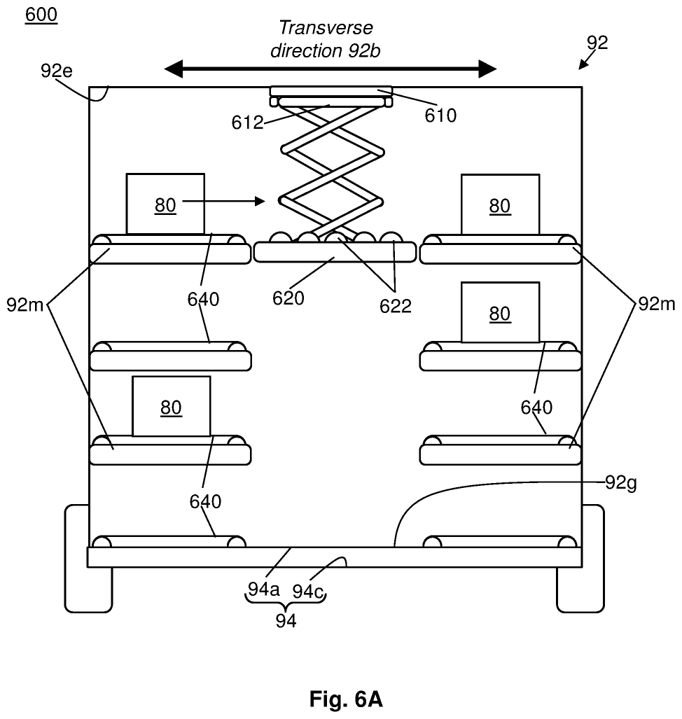

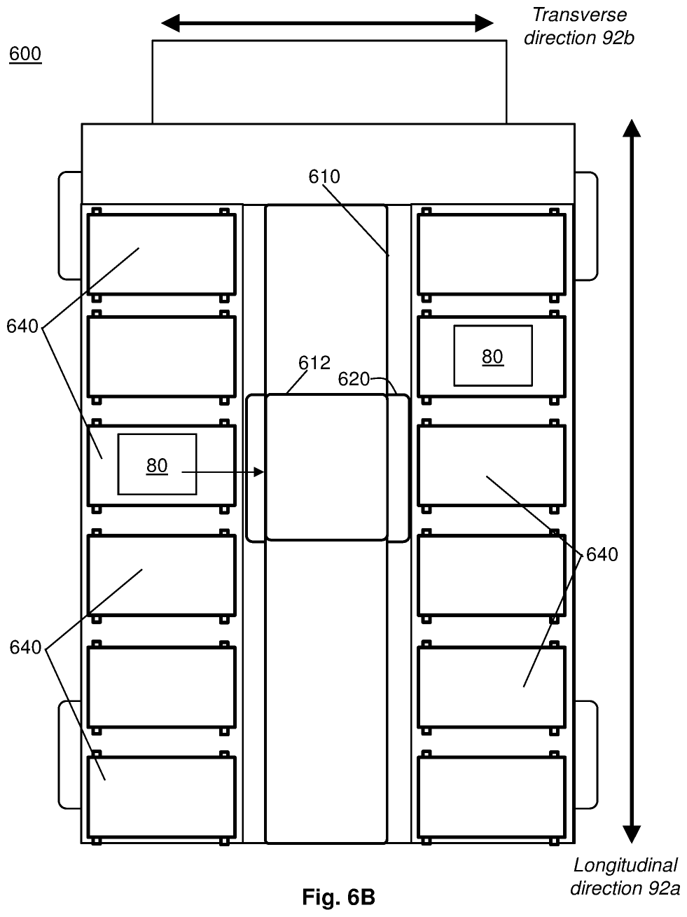

Reference is made to FIGS. 6A and 6B, which are 2D diagrams of a system 600 (e.g. displacement system) for moving items 80 operating in vehicle storage volume 92 and including a tray 620 and a plurality of conveyors 640 engageable with items 80, according to some embodiments of the invention. FIGS. 6A and 6B show schematic rear and top views of system 600 and vehicle storage volume 92.

System 600 may operate as system for moving items 80 within vehicle storage volume 92 (e.g. as described above with respect to FIGS. 1A and 1B).

System 600 may include a rail 610 (e.g. such as rail 210 described hereinabove) that may be coupled to ceiling 92e or floor 92g of vehicle storage volume 92 and extending in longitudinal direction 92a of storage volume 92. System 600 may include a sliding member 612 (e.g. such as sliding member 212 described hereinabove) that may be coupled to rail 610 and may move on rail 610 in longitudinal direction 92a.

System 600 may include a tray 620. Tray 620 may receive items 80. Tray 620 may temporarily accommodate items 80. System 600 may include a linkage 630 (e.g. such as linkage 230 described hereinabove) to elevate and lower tray 620 with respect to sliding member 612. At least part of tray 620 may be rotatable about an axis that is perpendicular (or substantially perpendicular) to tray 620 (e.g. as described above with respect to FIGS. 2A-2D).

System 600 may include a plurality of conveyors 640. Conveyors 640 may be coupled to shelves 92m and/or floor 92g of vehicle storage volume 92 (e.g. as shown in FIGS. 6A and 6B). Conveyors 640 may include conveyor belts (e.g. as schematically shown in FIGS. 6A and 6B), conveyor rollers or any other suitable components. Items 80 may be disposed on conveyors 640. Conveyors 640 may be rotated to move items 80 in directions that are perpendicular (or substantially perpendicular) to rail 612 and are parallel (or substantially parallel) to transverse direction 92b of vehicle storage volume 92.

In operation, tray 620 may be moved to position tray 620 in front of selected item 80, while respective conveyor belt 640 may be rotated to move selected item 80 to tray 620. Tray 620 may be then moved to the desired location within storage volume 92 and selected item 80 may be unloaded from tray 620 at the desired location.

In some embodiments, tray 620 includes a structure 622 that may engage with items 80 to facilitate loading of items 80 on tray 620 or unloading of items 80 from tray 620. In the example, of FIGS. 6A and 6B, structure 622 includes wheels (e.g. omni wheels). Structure 622 may include devices other than wheels 622. For example, structure 622 may include a conveyor belt, rollers or any other suitable device that may engage with items 80.

System 600 may include additional components that are not shown in FIGS. 6A-6B for simplicity. For example, system 600 may include a controller (e.g. such as controller 120 described above with respect to FIGS. 1A-1B), sensors (e.g. such as sensors 130 described above with respect to FIGS. 1A-1B), one or more batteries (e.g. such as one or more batteries 140 described above with respect to FIGS. 1A-1B) or any other suitable components.

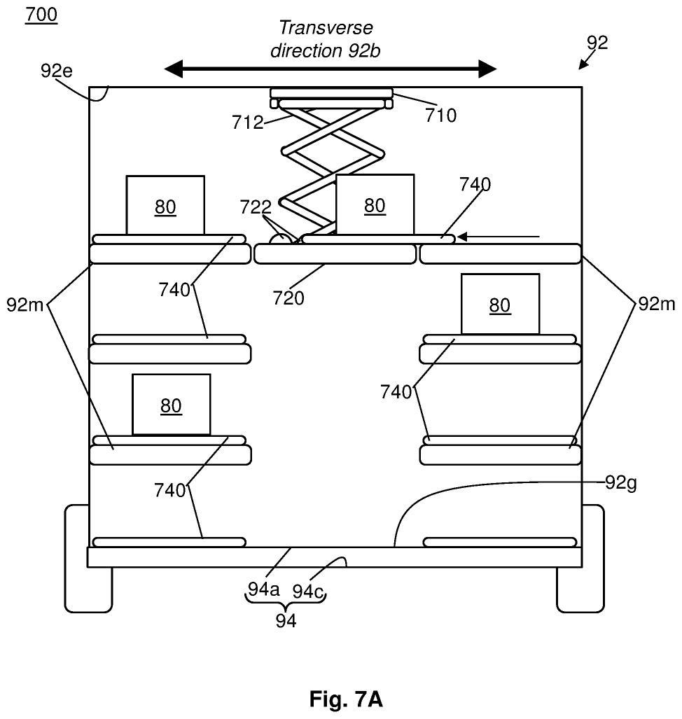

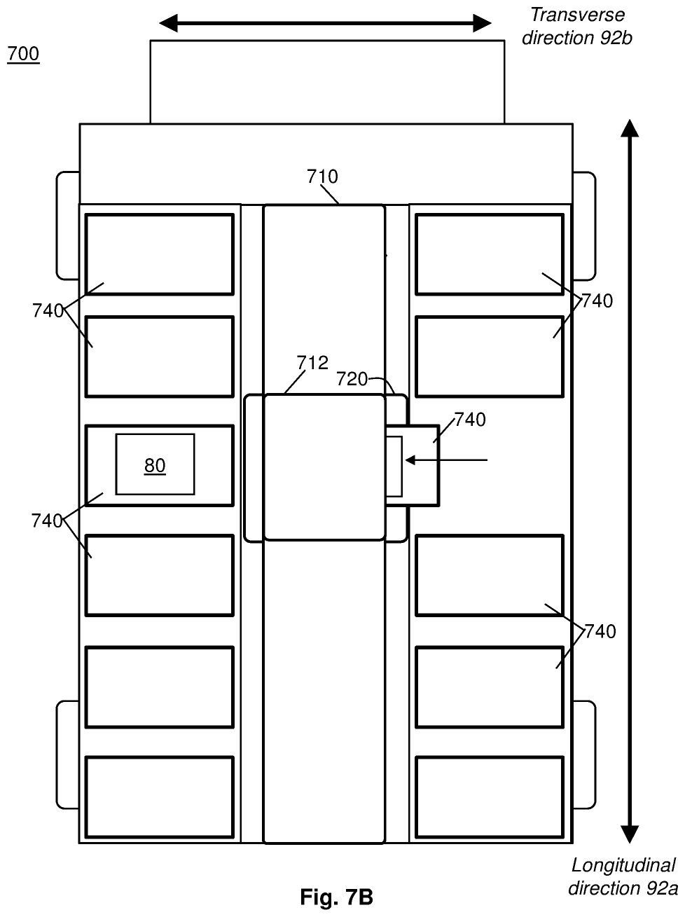

Reference is made to FIGS. 7A and 7B, which are 2D diagrams of a system 700 (e.g. displacement system) for moving items 80 operating in vehicle storage volume 92 and including a tray 720 and a plurality of extendable surfaces 740 engageable with items 80, according to some embodiments of the invention. FIGS. 7A and 7B show schematic rear and top views of system 700 and vehicle storage volume 92.

System 700 may operate as system 100 for moving items 80 within vehicle storage volume 92 (e.g. as described above with respect to FIGS. 1A and 1B).

System 700 may include a rail 710 (e.g. such as rail 210 described hereinabove) that may be coupled to ceiling 92e or floor 92g of vehicle storage volume 92 and extending in longitudinal direction 92a of storage volume 92. System 700 may include a sliding member 712 (e.g. such as sliding member 212 described hereinabove) that may be coupled to rail 710 and may move on rail 710 in longitudinal direction 92a.

System 700 may include a tray 720. Tray 720 may receive items 80. Tray 720 may temporarily accommodate items 80. System 700 may include a linkage 730 (e.g. such as linkage 230 described hereinabove) to elevate and lower tray 720 with respect to sliding member 712. At least part of tray 720 may be rotatable about an axis that is perpendicular (or substantially perpendicular) to tray 720 (e.g. as described above with respect to FIGS. 2A-2D).

System 700 may include a plurality of extendable and retractable surfaces 740. Extendable surfaces 740 may be coupled to shelves 92m and/or floor 92g of vehicle storage volume 92 (e.g. as shown in FIGS. 7A and 7B). Items 80 may be disposed on extendable surfaces 740. Extendable surfaces 740 may be extended with respect to shelves 92m and/or floor 92g in directions that are transverse to rail 712 and are parallel (or substantially parallel) to transverse direction 92b of vehicle storage volume 92.

In operation, tray 720 may be moved to position tray 720 in front of selected item 80, while respective extendable surface 740 may be extended with respect to respective shelf to move selected item 80 to tray 720. Tray 720 may be then moved to the desired location within storage volume 92 and selected item 80 may be unloaded from tray 720 at the desired location.

In some embodiments, tray 720 includes a structure 722 that may engage with items 80 to facilitate loading of items 80 on tray 720 or unloading of items 80 from tray 720. In the example, of FIGS. 7A and 7B, structure 722 includes wheels (e.g. omni wheels). Structure 722 may include devices other than wheels 722. For example, structure 722 may include a conveyor belt, rollers, or any other suitable device that may engage with items 80.

System 700 may include additional components that are not shown in FIGS. 7A-7B for simplicity. For example, system 700 may include a controller (e.g. such as controller 120 described above with respect to FIGS. 1A-1B), sensors (e.g. such as sensors 130 described above with respect to FIGS. 1A-1B), one or more batteries (e.g. such as one or more batteries 140 described above with respect to FIGS. 1A-1B) or any other suitable components.

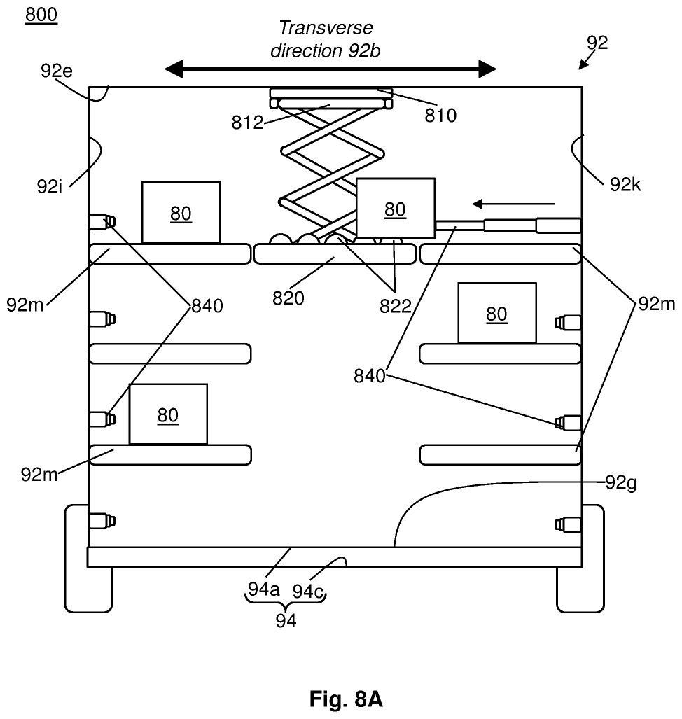

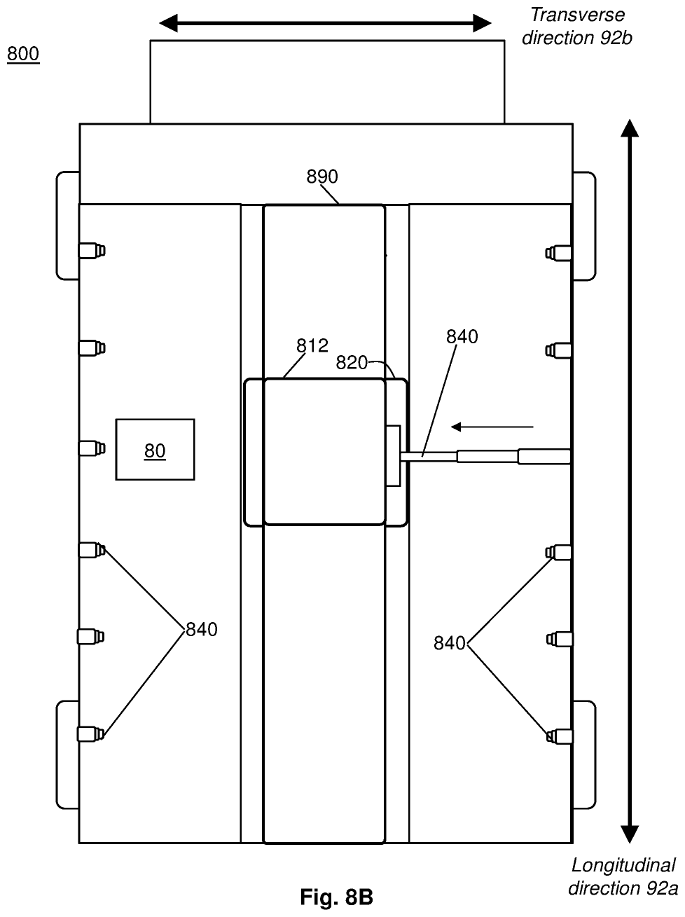

Reference is made to FIGS. 8A and 8B, which are 2D diagrams of a system 800 (e.g. displacement system) for moving items 80 operating in vehicle storage volume 92 and including a tray 820 and a plurality of actuators 840 engageable with items 80, according to some embodiments of the invention. FIGS. 8A and 8B show schematic rear and top views of system 800 and vehicle storage volume 92.

System 800 may operate as system 100 for moving items 80 within vehicle storage volume 92 (e.g. as described above with respect to FIGS. 1A and 1B).

System 800 may include a rail 810 (e.g. such as rail 210 described hereinabove) that may be coupled to ceiling 92e or floor 92g of vehicle storage volume 92 and extending in longitudinal direction 92a of storage volume 92. System 800 may include a sliding member 812 (e.g. such as sliding member 212 described hereinabove) that may be coupled to rail 810 and may move on rail 810 in longitudinal direction 92a.

System 800 may include a tray 820. Tray 820 may receive items 80. Tray 820 may temporarily accommodate items 80. System 800 may include a linkage 830 (e.g. such as linkage 230 described hereinabove) to elevate and lower tray 820 with respect to sliding member 812. At least part of tray 720 may be rotatable about an axis that is perpendicular (or substantially perpendicular) to tray 720 (e.g. as described above with respect to FIGS. 2A-2D).

System 800 may include a plurality of actuators (e.g. push and/or pull actuators) 840. Actuators 840 may be coupled to side walls 92i, 92k of vehicle storage volume 92 (e.g. as shown in FIGS. 8A and 8B). In some other embodiments, actuators 840 are coupled to shelves 92m. Actuators 840 may be extendable and retractable in directions that are transverse to rail 812 and that are perpendicular (or substantially perpendicular) to rail 812 and are parallel (or substantially parallel) to transverse direction 92b of vehicle storage volume 92.

In operation, tray 820 may be moved to position tray 820 in front of selected item 80, while respective actuator 840 may be extended to move selected item 80 to tray 820. Tray 820 may be then moved to the desired location within storage volume 92 and selected item 80 may be unloaded from tray 820 at the desired location.

In some embodiments, tray 820 includes a structure 822 that may engage with items 80 to facilitate loading of items 80 on tray 820 or unloading of items 80 from tray 820. In the example, of FIGS. 8A and 8B, structure 822 includes wheels (e.g. omni wheels). Structure 822 may include devices other than wheels 822. For example, structure 822 may include a conveyor belt or any other suitable device that may engage with items 80.

System 800 may include additional components that are not shown in FIGS. 8A-8B for simplicity. For example, system 800 may include a controller (e.g. such as controller 120 described above with respect to FIGS. 1A-1B), sensors (e.g. such as sensors 130 described above with respect to FIGS. 1A-1B), one or more batteries (e.g. such as one or more batteries 140 described above with respect to FIGS. 1A-1B) or any other suitable components.

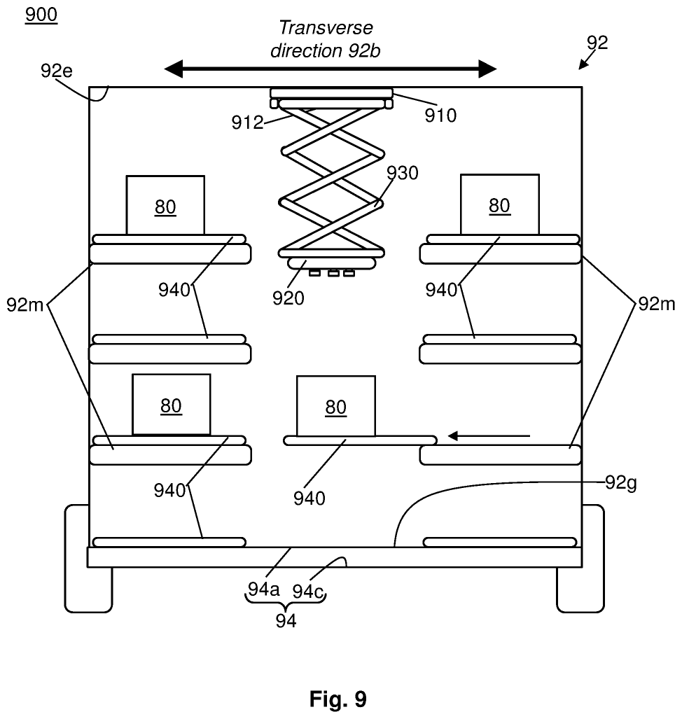

Reference is made to FIG. 9, which is a 2D diagram of a system 900 (e.g. displacement system) for moving items 80 operating in vehicle storage volume 92 and including an item holder 920 movable on a rail 910 and a plurality of extendable surfaces 940 engageable with items 80, according to some embodiments of the invention. FIG. 9 shows a schematic rear view of system 900 and vehicle storage volume 92.

System 900 may operate as system 100 for moving items 80 within vehicle storage volume 92 (e.g. as described above with respect to FIGS. 1A and 1B).

System 900 may include a rail 910 (e.g. such as rail 210 described hereinabove) that may be coupled to ceiling 92e of vehicle storage volume 92 and extending in longitudinal direction 92a of storage volume 92. System 900 may include a sliding member 912 (e.g. such as sliding member 212 described hereinabove) that may be coupled to rail 910 and may move on rail 910 in longitudinal direction 92a.

System 900 may include an item holder 920. Item holder 920 may engage with items 80. System 900 may include a linkage 930 (e.g. such as linkage 230 described hereinabove) to elevate and lower item holder 920 with respect to sliding member 912. Item holder 920 may be rotatable with respect to sliding member 912 about an axis 921 that is perpendicular (or substantially perpendicular) to rail 910. Item holder 920 may, for example, include gripping arms, anchors, grabber, suction cups or any other suitable device.

System 900 may include a plurality of extendable and retractable surfaces 940. Extendable surfaces 940 may be coupled to shelves 92m and/or floor 92g of vehicle storage volume 92 (e.g. as shown in FIG. 9). Items 80 may be disposed on extendable surfaces 940. Extendable surfaces 940 may be extended with respect to shelves 92m and/or floor 92g in directions that are transverse to rail 912 and are parallel (or substantially parallel) to transverse direction 92b of vehicle storage volume 92.

In operation, extendable surface 940 accommodating selected item 80 may be extended in a direction that is parallel to transverse direction 92b of vehicle storage volume 92 to position selected item 80 below rail 910. Item holder 920 may be moved to position item holder 920 above selected item 80. Item holder 920 may engage with selected item 80. Item holder 920 may be then moved to unload selected item 80 at the desired location.

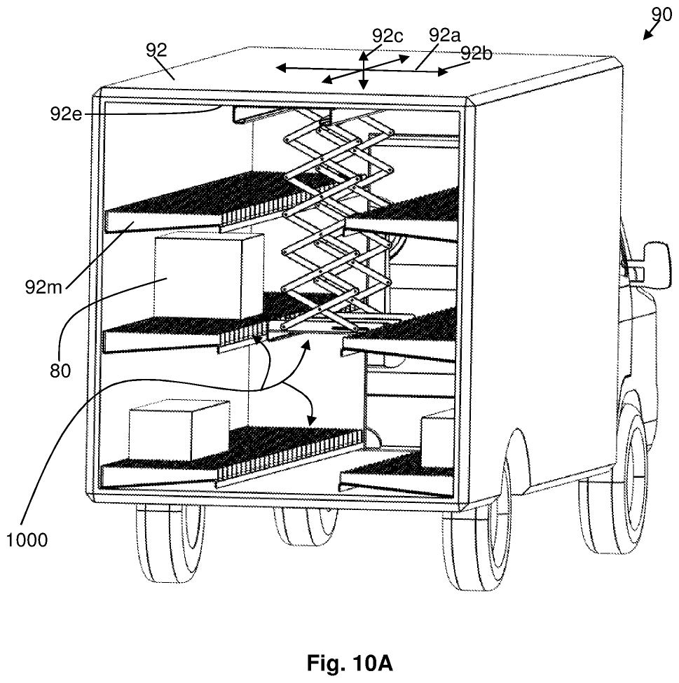

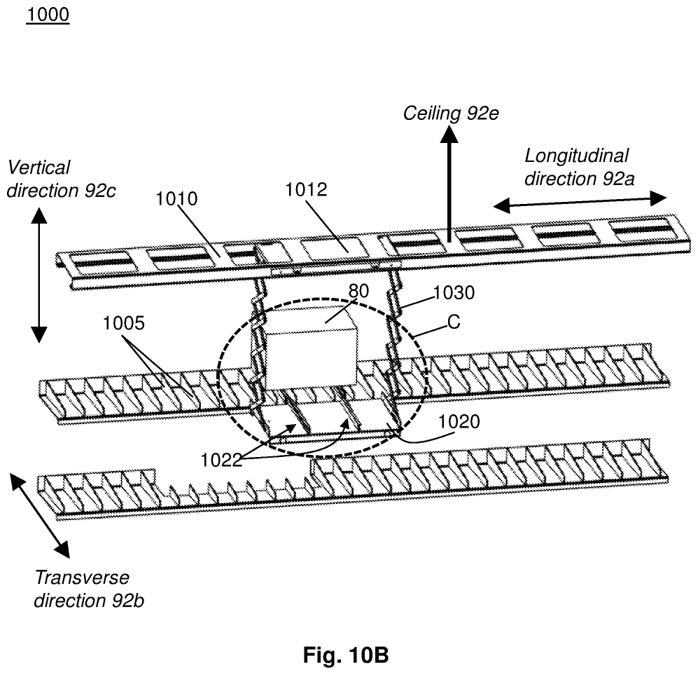

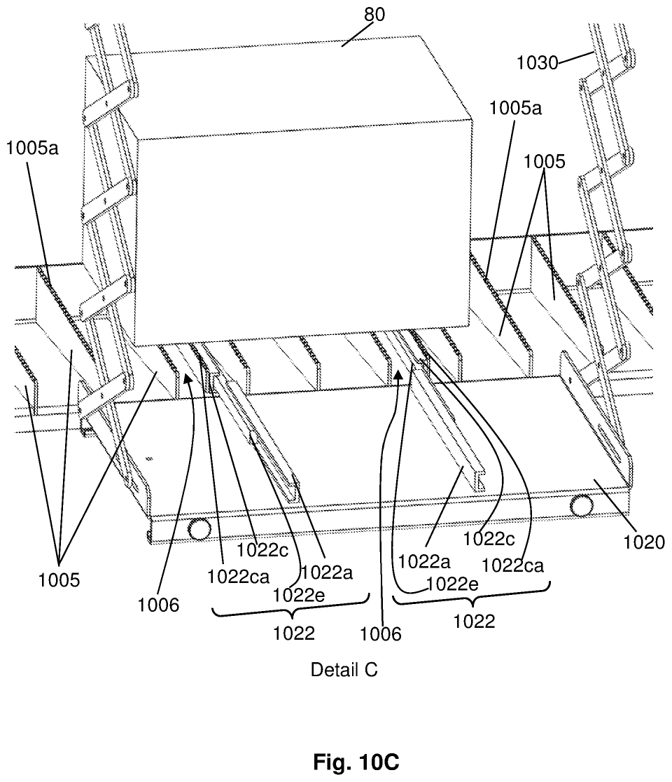

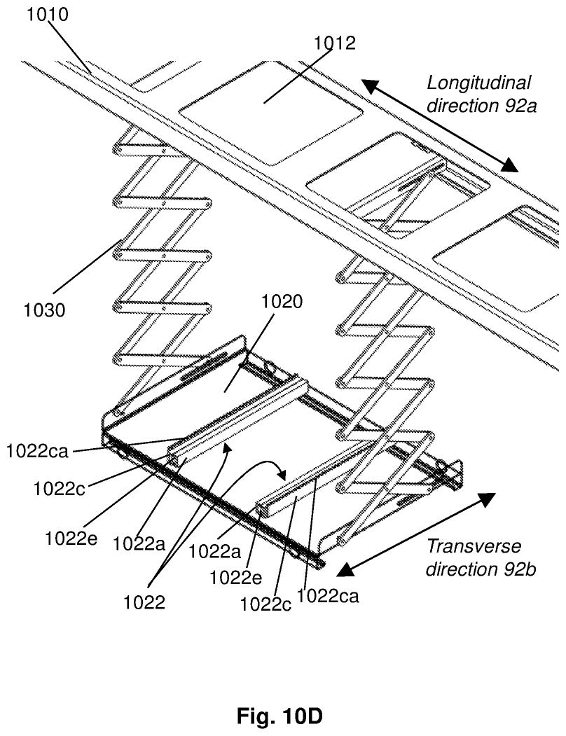

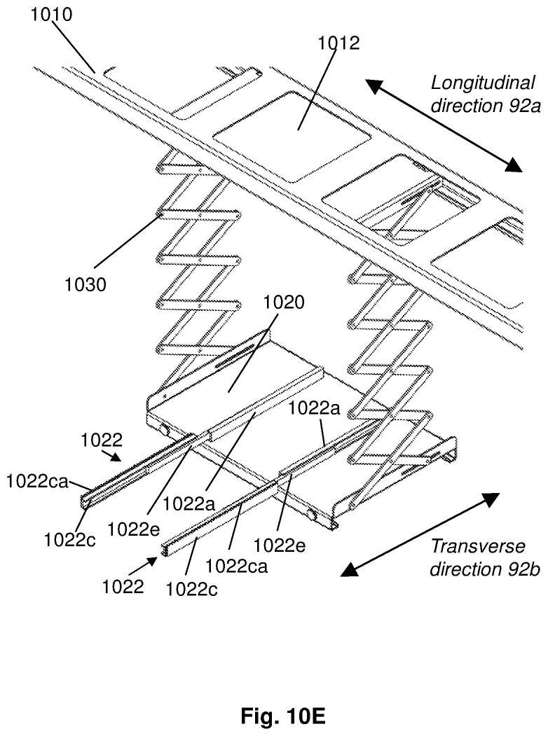

Reference is made to FIG. 10A, which is a 3D diagram of vehicle 90 and of a system 1000 (e.g. displacement system) for moving items 80 and including item supports 1005 and a tray 1020 with telescopic bars 1022, assembled within vehicle storage volume 92, according to some embodiments of the invention.

Reference is made also to FIG. 10B, which is a 3D diagram of shelves 92m of vehicle storage volume 92 and of system 1000 of FIG. 10A, according to some embodiments of the invention.

Reference is also made to FIG. 10C, which is a 3D diagram of an enlarged region C of FIG. 10B, according to some embodiment of the invention.

Reference is now made to FIGS. 10D and 10E, which are 3D diagrams of a rail 1010, slider 1012, linkage 1030, tray 1020 and telescopic bars 1022 of system 1000 of FIGS. 10A-10C, according to some embodiments of the invention.

System 1000 may operate as system 100 moving items 80 within vehicle storage volume 92 (e.g. as described above with respect to FIGS. 1A and 1B).

System 1000 may include a plurality of supports 1005. Supports 1005 may be assembled shelves 92m of vehicle storage volume 92. Supports 1005 may be integrated within shelves 92m. Supports 1005 may be assembled on side walls 92i, 92k of vehicle storage volume 92, e.g. instead of shelves 92m. Supports 1005 may be assembled on floor 92g of vehicle storage volume 92. Supports 1005 may distanced from each other such that hollow space 1006 is formed between adjacent supports 1005. Supports 1005 may be parallel (or substantially parallel) to transverse direction 92b of vehicle storage volume 92. Items 80 may be placed on supports 1005. Supports 1005 may support items 80. Each of supports 1005 may include an increased friction surface 1005a that contacts items 80 when items 80 are placed on support 1005 (e.g. as shown in FIG. 10C). Increased friction surfaces 1005a may prevent unintended slipping of items 80 from supports 1005. In the example of FIGS. 10A-10E, increased friction surfaces 1005a of supports 1005 include saw-tooth structures. Increased friction surfaces 1005a may include other forms of material or shapes than shown in FIGS. 10A-10E to increase the friction between surfaces 1005a and items 80.

System 1000 may include a rail 1010 (e.g. such as rail 210 described hereinabove) that may be coupled to ceiling 92e or floor 92g of vehicle storage volume 92 and may extend in longitudinal direction 92a of vehicle storage volume 92. System 1000 may include a sliding member 1012 (e.g. such as sliding member 212 described hereinabove) that may be coupled to rail 1010 and may move on rail 1010 in longitudinal direction 92a. System 1000 may include a tray 1020. Tray 1020 may receive items 80. Tray 1020 may temporarily accommodate items 80. System 1000 may include a linkage 1030 (e.g. such as linkage 230 described hereinabove) to elevate and lower tray 1020 with respect to sliding member 1012. At least part of tray 1020 may be rotatable about an axis that is perpendicular (or substantially perpendicular) to tray 1020 (e.g. as described above with respect to FIGS. 2A-2D).

Tray 1020 may include one or more telescopic bars 1022. Each of telescopic bars 1022 may be coupled to tray 1022. For example, tray 1020 may include two telescopic bars 1022. Telescopic bars 1022 may be distanced from each other. Telescopic bars 1022 may be parallel (or substantially parallel) to transverse direction 92b of vehicle storage volume 92. Telescopic bars 1022 may be parallel (or substantially parallel) to supports 1005.

Each of telescopic bars 1022 may include a first telescopic bar member 1022a that may be coupled to tray 1020 and a second telescopic bar member 1022c that may be extendable and retractable with respect first telescopic bar member 1022a in directions that are transverse (or substantially transverse) to rail 1010 and that are parallel (or substantially parallel) to transverse direction 92b of vehicle storage volume 92. Each of telescopic bars 1022 may include an intermediate telescopic bar member 1022e disposed between first and second telescopic bar members 1022a, 1022c.

In operation, tray 1020 may be moved to position tray 1020 in front of selected item 80. Second telescopic bar member 1022c may be extended in the direction that is parallel (or substantially parallel) to supports 1005 and may be inserted below selected item 80 into space 1006 between supports 1005 supporting selected item 80. Second telescopic bar members 1022c may be then retracted towards tray 1020 to position selected item 80 within the perimeter of tray 1020. Tray 1020 may be then moved to position unload selected item 80 at the desired location (e.g. as described hereinabove). In some embodiments, tray 1020 is elevated to pick up selected item 80 from supports 1005 by second telescopic bar members 1022c of telescopic bars 1022 prior to retracting second telescopic bar members 1022c towards tray 1020.

Second telescopic bar member 1022c of each of telescopic bars 1022 may include an increased friction surface 1022ca that contacts items 80. Increased friction surfaces 1022ca may prevent unintended slipping of items 80 from second telescopic bar members 1022c. In the example of FIGS. 10A-10E, increased friction surfaces 1022ca of second telescopic bar members 1022c include saw-tooth structures. Increased friction surfaces 1022ca may include other forms of material or shapes than shown in FIGS. 10A-10E to increase the friction between surfaces 1022ca and items 80.

In some embodiments, each of telescopic bars 1022 includes a lifting mechanism to elevate at least second telescopic bar member 1022c with respect to tray 1022 to pick up selected item 80 from supports 1005. In some embodiments, tray 1022 includes a lifting mechanism to elevate telescopic bar 1022 or at least telescopic bar member 1022c with respect to tray 1022 to pick up selected item 80 from supports 1005.

System 1000 may include additional components that are not shown in FIGS. 10A-10E for simplicity. For example, system 1000 may include a controller (e.g. such as controller 120 described above with respect to FIGS. 1A-1B), sensors (e.g. such as sensors 130 described above with respect to FIGS. 1A-1B), one or more batteries (e.g. such as one or more batteries 140 described above with respect to FIGS. 1A-1B) or any other suitable components.

Embodiments of the present invention may improve handling of items within the storage volume of the delivery van. The disclosed systems and devices may significantly reduce an effort of the operator (e.g. the driver or the loader) during loading and/or unloading of items from the van storage volume thus making the items delivery or distribution process more cost effective and faster.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system for moving items in a storage volume of a vehicle, the system comprising:
one or more automatically controlled mechanical devices comprising:
a rail couplable to one of a ceiling or a floor of the storage volume of the vehicle and extending in a longitudinal direction of the storage volume;
a sliding member coupled to the rail and movable on the rail in the longitudinal direction;
a tray to receive the items, the tray being coupled to the sliding member using a linkage that is extendable and retractable in a vertical direction with respect to the sliding member; and
an item holder coupled to the tray, the item holder is movable with respect to the tray in a first direction and in a second direction that is opposite to the first direction, the first direction and the second direction being transverse to the rail, to engage with the items disposed on both sides of the tray and to place the items on the tray; and
a controller to control the one or more automatically controlled mechanical devices to engage with the items and to move the items within the storage volume.

2. (canceled)

3. The system of claim 1, wherein at least a part of the tray is rotatable about at axis that is substantially perpendicular to the tray.

4. (canceled)

5. (canceled)

6. (canceled)

7. The system of claim 1, wherein the one or more automatically controlled mechanical devices comprises a linkage that couples the item holder to the tray, the linkage being extendable and retractable in the first and second directions that are transverse to the rail to move the item holder in said directions.

8. The system of claim 7, wherein the linkage is extendable so as to move the item holder beyond outer edges of the tray in both the first and second directions.

9. The system of claim 7, wherein the linkage is extendable so as to move the item holder along a substantially straight line.

10. The system of claim 7, wherein the linkage is extendable so as to move the item holder at substantially the same height with respect to the tray.

11. The system of claim 7, wherein the linkage is coupled to the slider of the tray.

12. The system of claim 7, wherein the linkage comprises:
a first arm coupled to the slider and rotatable with respect to the slider about a first arm rotation axis that is substantially perpendicular to the bar; and
a second arm coupled to the first arm and rotatable with respect to the first arm about a second arm rotation axis that is substantially parallel to the first arm rotation axis, the second arm being rotatably coupled to the item holder.

13. (canceled)

14. (canceled)

15. (canceled)

16. (canceled)

17. The system of claim 1, wherein the tray comprises:
a telescopic bar being transverse to the rail, the telescopic bar comprises:
a first telescopic bar member coupled to the tray; and
a second telescopic bar member extendable and retractable with respect to the first telescopic bar member in directions that are transverse to the rail;
a slider movable on the second telescopic bar member;
wherein the item holder is coupled to the slider.

18. The system of claim 17, wherein the second telescopic bar member is extendable beyond outer edges of the tray to move the item holder beyond the outer edges of the tray in both the first and second directions.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. The system of claim 1, wherein the one or more automatically controlled mechanical devices comprises:
a plurality of extendable and retractable surfaces coupled to at least one of shelves and a floor of the storage volume, the extendable surfaces being extendable in directions that are transverse to the rail to move the items in a region below the rail.

34. The system of claim 1, wherein the controller is to control the automatically controlled mechanical device to move the items from a loading location within the storage volume to selected locations within the storage volume.

35. The system of claim 1, wherein the controller is to control the automatically controlled mechanical device to move items from their respective locations within the storage volume to an unloading location within the storage volume.

36. The system of claim 1, wherein the controller is to control the automatically controlled mechanical device to move items from their respective locations within the storage volume to other locations within the storage volume.

37. The system of claim 1, wherein the controller is to control the automatically controlled mechanical device to move items from their respective locations within the storage volume to other locations within the storage volume to balance a center of gravity of the vehicle.

38. The system of claim 1, wherein the controller is to select the items based on at least one of a delivery plan, vehicle geolocation data, items identification data and items storage location data.

39. (canceled)

40. (canceled)

41. The system of claim 1, comprising a battery to provide power to the automatically controlled mechanical device and the controller, the battery being disposed within a chassis of the vehicle between an upper surface and a bottom surface of the chassis.

42. (canceled)

43. A vehicle comprising:
the system according to claim 1; and
the storge volume in which the system is assembled.

44. The vehicle of claim 43, wherein the storage volume is removably mountable on a chassis of the vehicle.

45. (canceled)

46. (canceled)
